(19) United States
(12) Patent Application Publication
(10) Pub. No.: US 2021/0248673 A1
(43) Pub. Date: Aug. 12, 2021

(54) INFORMATION GATHERING AND MANAGEMENT

(71) Applicant: Wells Fargo Bank, N.A., San Francisco, CA (US)

(72) Inventors: Abraham Drucker, San Fransisco, CA (US); Allen R. Blatter, Clayton, CA (US); Jacob A. Williams, Surprise, AZ (US); Giovanni A. Moro, San Francisco, CA (US); Michael J. Boggs, Folsom, CA (US); Ravi K. Maganti, Eden Prairie, MN (US)

(21) Appl. No.: 15/332,626

(22) Filed: Oct. 24, 2016

(51) Int. Cl. G06Q 40/02; G06F 3/048

(52) U.S. Cl. CPC G06Q 40/025; G06F 3/048

(57) ABSTRACT

An information gathering and management system generates a user interface configured to receive a process initiation, such as a loan application, from a customer. Customer information required for the initiated process is determined, and a first portion of the required customer information that is available from a first data source is identified and displayed on the user interface. A second portion of the required customer information that is not available from the first data source is identified and displayed on the user interface. The second portion of the required customer information is received from the customer via the user interface.

### BACKGROUND

Many financial processes, such as a loan application process, require a customer to provide many pieces of information. For example, the loan application process may require a potential borrower to submit a variety of financial information such tax returns, prior paychecks, credit card info, bank balances, etc. to the financial institution. The lender further analyzes additional information, such as the borrower's credit report, to determine loan eligibility. Assembling and providing this information to the financial institution can be a tedious and daunting task for the customer, especially for those inexperienced with the process

### SUMMARY

In accordance with certain aspects of the present disclosure, information gathering and management systems and methods are described. For example, an information gathering and management system includes a processor and a memory accessible by the processor. The memory stores program instructions that configure the processor to implement a method that includes generating a user interface configured to receive a process initiation, such as a loan application, from a customer. Customer information required for the initiated process is determined, and a first portion of the required customer information that is available from a first data source is identified and displayed on the user interface. The first data source may include, for example, customer accounts internal to the financial institution associated with the initiated process, and/or accounts external to the financial institution. A second portion of the required customer information that is not available from the first data source is identified and displayed on the user interface. The second portion of the required customer information is received from the customer via the user interface. Thus, rather than requiring the customer assemble and provide all of the required information, the process is simplified for the customer by identifying and obtaining at least some of the required information from other sources.

### DESCRIPTION OF THE DRAWINGS

FIG. 1 is a block diagram illustrating an example of an information gathering and management system in accordance with aspects of the present disclosure.

FIG. 2 is a flow diagram illustrating an example of an information gathering and management process in accordance with aspects of the present disclosure.

FIG. 3 is block diagram illustrating an example of data flow for a system such as that shown in FIG. 1.

FIG. 4 a flow diagram illustrating further aspects of an example of an information gathering and management process in accordance with aspects of the present disclosure.

FIG. 5 is a block diagram illustrating portions of an example computer system.

### DETAILED DESCRIPTION

In the following Detailed Description, reference is made to the accompanying drawings, which form a part hereof, and in which is shown by way of illustration specific embodiments in which the invention may be practiced. The following detailed description, therefore, is not to be taken in a limiting sense.

Financial processes, such as a loan application process, require a customer to provide information to the financial institution such as tax returns, prior paychecks, credit card info, bank balances, etc. Often, much of the required information is available from sources other than the customer. For example, a customer may apply for a loan from a financial institution. It is not unusual for that customer to also hold other accounts, such as checking accounts, saving accounts, credit card accounts, etc., at the same financial institution. Further information required for the financial process may be available from other sources, such as other financial institutions, government agencies, credit bureaus, employers, etc. It would greatly simplify the process for the customer if the potential borrower were to obtain available information from other sources, and only require the customer to provide information not available from other sources. Communicating such information needs and obtaining customer information in this manner through a convenient user interface would further improve efficiency of the computer systems used to process such financial processes, in addition to improving the customer's experience with the process.

Some known financial systems and processes require customers to provide all required customer information, regardless of that information being available from other sources. This can be particularly frustrating for a customer when he or she is required to provide the same information for multiple processes. For example, when a customer applies for a home mortgage loan, many financial documents must be assembled and submitted during the loan application process. If the same customer subsequently initiates another financial process, such as applying for a home equity line of credit, the same information may need to be assembled and submitted for the application for the home equity line of credit—even if the same financial institution handles both loan application processes.

Some example processes and systems disclosed herein assemble customer information from sources other than the customer himself, then request and obtain from the customer only information not available from other sources. This can simply the process for the customer. For example, in one disclosed embodiment, data sources internal and external to a financial institution are considered. A risk analysis for a customer of the financial institution is first conducted to assess what information is required for a particular financial process, such as a loan application. Information about the customer is then gathered from internal sources at the financial institution and/or other sources that are external to the financial institution, such as third party sources. Rules are applied to match the information gathered with the information required based on the risk analysis. An analysis of any missing data is conducted to assess whether any of the missing data can be accessed via other sources. The remaining missing data is then requested from the customer via a user interface. The completed application is then provided to the customer with the automatically gathered information highlighted for verification by the customer.

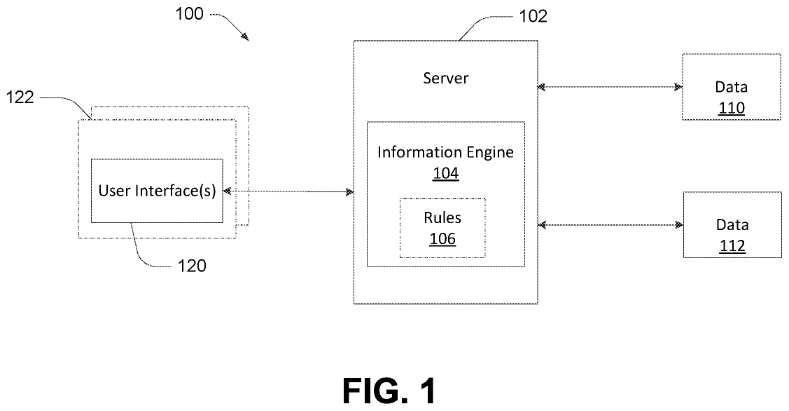

FIG. 1 is a block diagram illustrating an example system 100 that includes a computing system such as a computer 102 implementing an information engine 104. In some examples, the computing system 102 is a server computer at a financial institution such as a bank, brokerage firm, mortgage company, etc. Other examples of financial institutions are possible. Further, the server 102 may be implemented by one or more computer systems. Various data sources 110, 112 are accessible by the server 102. For example, the first data source 110 may be one or more databases associated with the financial institution computer 102, storing information regarding internal customer accounts. The second data source, for example, could be one or more external databases storing third party information external to the financial institution. Thus, the first data source 110 could be a local component of the server 102, though not necessarily located in close physical proximity to the server 102. For example, the first data source 110 could be accessible by the server 102 over local or wide area business networks or over other networks such as the internet.

In general, the computer 102 is operable to access the first and second data sources 110, 112 and obtain customer information required for a financial process such as a loan application based on predefined rules so that the customer is not required to personally provide all of the required information and documents. One or more user interfaces 120 are configured to display information for a customer such as information required for the particular financial transaction, information available from internal sources such as the customer's accounts at the financial institution handling the requested loan or other process, information available from external sources, missing information, etc. Additionally, the user interface 120 is configured to notify the customer of missing information, or “gaps,” and to allow the customer to securely provide the missing documents and information via the user interface 120. The user interface 120 could be implemented on a user computer 122, which could be any of a number of suitable devices such as a desktop computer, laptop computer, tablet device, smart phone, etc. that communicates with the server 102, for example, via a network such as the internet.

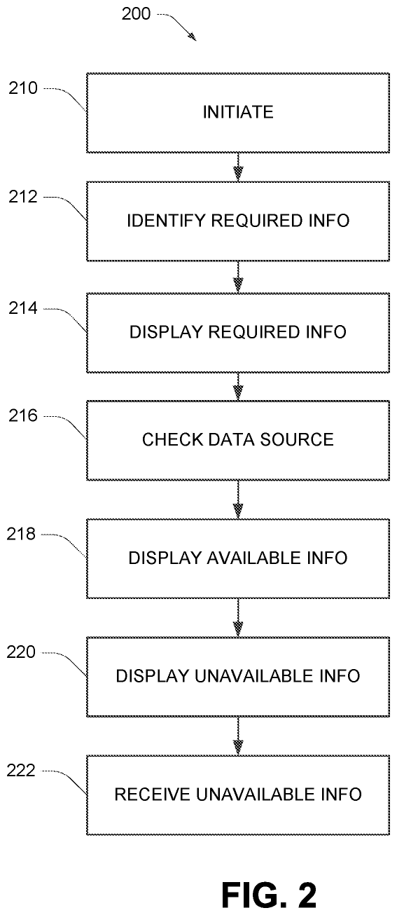

FIG. 2 is a flow diagram illustrating aspects of a method 200 executed by the computer 102. In block 210 of FIG. 2, a financial process, such as a loan application, is initiated by a customer using the user interface 120. Once the process has been initiated, the information engine 104 implemented by the computer 102 determines what information is required for the initiated process in block 212. For instance, if the process initiated at the operation 210 is a mortgage application, a risk assessment may be conducted on the customer at block 212 to determine the information required for the customer's loan application. The required information may be displayed for the customer on the user interface at block 214.

Rather than require the customer provide all of the required information, the information engine 104 identifies a first portion of the required customer information that is available from one or more data sources, such as the data sources 110 and/or 112 shown in FIG. 1. For example, the information engine 104 may execute a process in which financial institution data from various internal sources is gathered. Third party data sources (external to the financial institution for which the process was initiated at block 210) may also be considered to obtain the customer's information, rather than directly from the customer. Third party data can include publicly-accessible data, credit reports, government data, information from screen scrapers/data aggregators/APIs, etc. In the case of a home mortgage application, the data gathered can also include information about the home involved (disclosures, appraisal information, inspection information, etc.). To access such third party data, permission from the customer to the financial institution is typically required. This permission is granted via the user interface in some examples.

In block 218, the first portion of the required customer information identified in block 216 is displayed on the user interface 120, and the remaining required information, or the information gap, is displayed on the user interface for the customer in block 220. The customer may then provide the remaining information via the user interface or through other desired channels such as mailing physical documents to the financial institution. After the data is gathered, the data can be categorized and stored for later use in other applications or future activities.

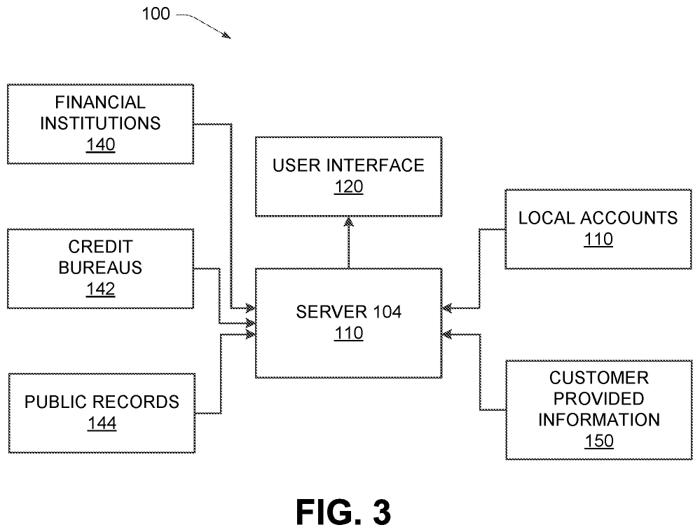

As noted earlier, in some implementations, both internal information sources (such as the data source 110) and external information sources (such as the data source 112) may be considered to assemble the required customer information, without requiring the customer take the time and effort to provide this information. FIG. 3 illustrates examples of various data sources. In addition to any customer accounts 110 local to the financial institution, sources of the required information include other financial institutions 140 (banks, credit unions, credit card companies, etc.), credit bureaus 142 (Equifax, Experian, TransUnion, etc.), public records 144 (local, county, state, federal property tax records, etc.), and the like. Thus, in some embodiments, for example, information available from local accounts 110 may be identified and displayed on the user interface 120, and additionally information available from other sources 140, 142, 144 may additionally be identified and displayed for the customer. Remaining required information may then be displayed and obtained directly from the customer, as shown in block 150 of FIG. 3. Information provided by the customer could include, for example, images of documents, digital documents, bank account records, public records, etc.

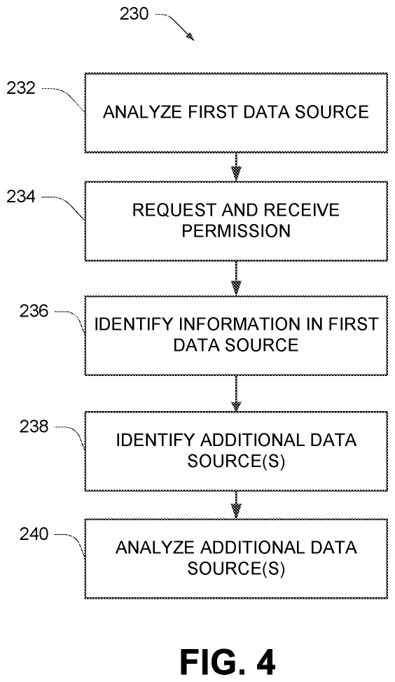

In some implementations, the server computer 102 additionally implements a rules engine 106 that stores and applies predetermined data rules used in analyzing data from the data sources 110, 112. For example, rules used in the information analysis by the information engine 104 include rules applied to match the information gathered in operations 218 and 222 of FIG. 2 with the required information identified in block 212. FIG. 4 illustrates further aspects of such an information gathering process 230.

As noted above, data sources (other than the customer himself) may include both internal data sources 110 and external data sources 112. In some embodiments, the information and rules engines 104, 106 are configured to analyze the internal data sources 110 to identify potential external data sources 112 in addition to identifying required information itself. For instance, the rules engine 106 may include rules implemented by the information engine 104 to analyze a first data source such as the customer's checking account in block 232 of FIG. 4. The rules engine 106 may include rules for identifying key words or phrases that possibly identify required information and/or other data sources. Deposits to the customer's account through a payroll service, for example, could identify customer income information as indicated in block 236. Referring to FIG. 3, payments made from the customer's local account 110 to other financial institutions 140 could indicate loans, credit card accounts, consumer credit accounts, etc. at such external financial institutions 140 as shown in block 238 of FIG. 4. With the proper permissions and information from the customer as indicated in operation 234, these external accounts 140 could be accessed and analyzed by the information engine 104 to obtain required information as indicated in block 240.

Similarly, credit reports provided by credit bureaus 142 may be analyzed by the information engine 104 using predetermined rules 106 to identify other financial accounts from which required information may be obtained, without the need for the customer to directly provide this information.

In some implementations, the user interface 120 includes a loan application “wizard” that presents the customer with requests for data that were not found in the internal or external data sources, among other things. Further, the user interface 120 may be configured such that the wizard can request the information using natural language. In this manner, the wizard minimizes the number of questions/inquiries to the customer to limit customer impact. The wizard may further be configured to present a request to access the customer's third party data source, which may provide various required data elements and documents. The loan application wizard can also use financial ontologies to make inferences in the gathered data to answer data that is perceived as missing.

Referring back to FIG. 2, required information that cannot be obtained from local data sources 110 or external data sources 112, or “data gaps,” are displayed for the customer on the user interface at block 220. Further, in block 222, the customer may provide the missing information via the user interface 120 or otherwise. Information retrieved from local data sources 110 (accounts, mortgage, loans, etc., at the financial institution associated with the server 102), information retrieved from external data sources 112, and information received from the customer may be stored in a database or “vault” such as one of more of the databases comprising the first data source 110.

In some embodiments, the information collected and stored in the vault includes images of physical documents and digital documents such as XML documents. The physical and/or digital documents may include, for example, tax returns and related documents, employment records, business records, credit reports, etc. Among other things, storing such assembled information in databases associated with the local data sources 110 allows subsequent use of the data for future financial processes. For example, if information is assembled for a mortgage application and stored in the vault, much of the same information could later be used if the same customer applies for a home equity line of credit.

When all required information is gathered, the customer may then be presented with an auto-filled loan application, for example, via the user interface 120. The information engine 104 may further apply rules 106 to analyze the received information. For instance, if the information engine 104 determines that information that is potentially stale or outdated may be highlighted in the loan application.

In conjunction with presenting the auto-filled application, or at a point prior thereto, information obtained by the information engine 104 automatically from the internal data sources 110 and/or the external data sources 112 may be presented to the user via the user interface, such that the customer may review and verify such information, and provide permission to use this information in the initiated process such as the loan application. For example, the user interface may use a pop-up field or other interface to allow the customer to validate or change information in highlighted fields.

In some examples, application programming interfaces (API) are created to allow applications to access various user accounts with user authorization.

In addition to storing various customer-granted permissions in metadata associated with gathered information and documents, information regarding information expiration, required purge timeframes, etc. may be included.

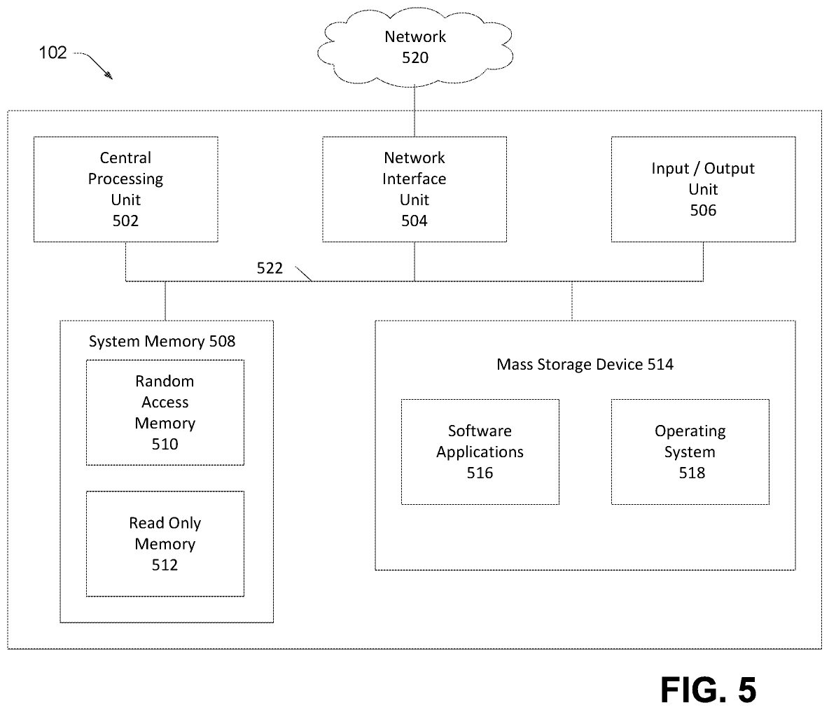

FIG. 5 schematically illustrates an example of the server computer 102, which includes at least one processor (“CPU”) 502, a system memory 508, and a system bus 522 that couples the system memory 508 to the CPU 502. The system memory 508 includes a random access memory (“RAM”) 510 and a read-only memory (“ROM”) 512. A basic input/output system that contains the basic routines that help to transfer information between elements within the server computer 102, such as during startup, is stored in the ROM 512. The server computer 102 further includes a mass storage device 514. The mass storage device 514 is able to store software instructions and data. As noted above, the local data sources 110 could be implemented by the mass storage device 512, and one or both of the data sources 110, 112 could be implemented by other computer systems accessible by the server 102. A processor, system memory and mass storage device similar to that in FIG. 5 are also included in each of the devices providing the user interfaces 120.

The mass storage device 514 is connected to the CPU 502 through a mass storage controller (not shown) connected to the system bus 522. The mass storage device 514 and its associated computer-readable data storage media provide non-volatile, non-transitory storage for the server computer 102. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 102.

According to various embodiments of the invention, the server computer 102 may operate in a networked environment using logical connections to remote network devices through the network 520, such as a wireless network, the Internet, or another type of network. The server computer 102 may connect to the network 520 through a network interface unit 504 connected to the system bus 522. It should be appreciated that the network interface unit 504 may also be utilized to connect to other types of networks and remote computing systems. The server computer 102 also includes an input/output controller 506 for receiving and processing input from a number of other devices, including a touch user interface display screen, or another type of input device. Similarly, the input/output controller 506 may provide output to a touch user interface display screen or other type of output device.

As mentioned briefly above, the mass storage device 514 and the RAM 510 of the server computer 102 can store software instructions and data. The software instructions include an operating system 518 suitable for controlling the operation of the server computer 102. The mass storage device 514 and/or the RAM 510 also store software instructions, that when executed by the CPU 502, cause the server computer 102 to provide the functionality of the server computer 102 discussed in this document. For example, the mass storage device 514 and/or the RAM 510 can store software instructions that, when executed by the CPU 502, cause the server computer 102 to implement the information engine 104 and the rules engine 106 shown in FIG. 1 for applying the various processes described herein, among other things.

Although various embodiments are described herein, those of ordinary skill in the art will understand that many modifications may be made thereto within the scope of the present disclosure. For instance, examples related to home loans are included herein, though the disclosed systems and methods are also applicable to many other financial processes, such as personal and business loans, credit card accounts, home equity lines of credit, mortgage refinances, etc. Accordingly, it is not intended that the scope of the disclosure in any way be limited by the examples provided.

1. An information gathering and management system, comprising:
a server;
a processor;
a first customer information database that is internal to a financial institution;
a second customer information database that is external to the financial institution;
a non-transitory memory accessible by the processor storing program instructions that configure the processor to:
(a) generate a user interface configured to receive, via a display screen of the user interface, a process initiation from a customer;
(b) identify customer information required for the initiated process;
(c) identify a first portion of the required customer information that is available from the first customer information database;
(d) subsequent to (c), receive at the server the first portion of the required customer information from the first customer information database;
(e) subsequent to (d):
(e1) identify, based on transaction information and one or more key words in the received first portion of the required customer information, a second portion of the required customer information that is not available from the first customer information database; and
(e2) identify, based on the one or more key words, the second customer information database as storing the second portion of the required customer information;
(f) in response to (e), request, using the display screen, permission to access the second portion of the required customer information from the second customer information database;
(g) subsequent to (f), receive at the server, via the display screen, the requested permission;
(h) subsequent to (g), receive at the server the second portion of the required customer information from the second customer information database;
(i) subsequent to (g), identify a third portion of the required customer information that is not available from any of the first customer information database and the second customer information database;
(j) subsequent to (i), request from the customer, using the display screen, the third portion of the required customer information;
(k) subsequent to (j), receive at the server the third portion of the required customer information from the customer via the display screen;
(l) obtain, using a screen scraper, a fourth portion of the required customer information;
(m) subsequent to (k) and (l), auto-fill an application for a home mortgage with the first portion of the required customer information from the first customer information database, the second portion of the required customer information from the second customer information database, the third portion of the required customer information from the customer, and the fourth portion of the required customer information obtained using the screen scraper;
(n) subsequent to (m), display, using the display screen, the auto-filled application for a home mortgage including the first, second, third and fourth portions of the required customer information;
(o) automatically determine that a piece of information of the first, second, third and fourth portions of the required customer information may be outdated;
(p) highlight on the display screen displaying the auto-filled application, and based on the determination of the step (o), the piece of information;
(q) store in the first customer information database or a third customer information database that is internal to the financial institution, the first, second and third portions of the required customer information as XML documents and images of physical documents, the stored XML, documents and images of physical documents including associated metadata, the associated metadata including, with respect to each document, customer-granted permission metadata and information expiration metadata; and
(r) retrieve at least some of the stored XML documents and images of physical documents for an application, by the customer, for a home equity line of credit by the customer.

2-3. (canceled)

4. The system of claim 1, wherein the program instructions further configure the processor to analyze the first portion of the required customer information to extract the first portion of the required customer information from the first customer information database.

5. The system of claim 3, wherein the memory stores predetermined rules applied by the processor to analyze the first portion of the required customer information to identify the second customer information database.

6-7. (canceled)

8. The system of claim 1, further comprising a user computer configured to communicate with the processor system via a network, wherein the user interface is displayed by the user computer.

9. The system of claim 1, wherein the third portion of the required customer information received from the customer via the user interface includes at least one of images of documents, digital documents, bank account records, and public records.

10. The system of claim 1, wherein the processor is configured to store the information received via the user interface in the third customer information database.

11-20. (canceled)
